(19) United States
(12) Patent Application Publication
(10) Pub. No.: US 2021/0229048 A1
(43) Pub. Date: Jul. 29, 2021

(54) SELECTIVELY PERMEABLE GRAPHENE OXIDE ELEMENT

(71) Applicant: NITTO DENKO CORPORATION, Osaka (JP)

(72) Inventors: Shijun Zheng, San Diego, CA (US); Lin Weiping, Carlsbad, CA (US); Peng Wang, San Diego, CA (US); Isamu Kitahara, San Diego, CA (US); Bita Bagge, Vista, CA (US); John Ericson, Poway, CA (US)

(21) Appl. No.: 17/050,812

(22) PCT Filed: May 2, 2019
(86) PCT No.: PCT/US2019/030365

§ 371 Date: Oct. 26, 2020

Related U.S. Application Data
(60) Provisional application No. 62/666,044, filed on May 2, 2018.
(60) Provisional application No. 62/688,308, filed on Jun. 21, 2018.

(51) Int. Cl. B01D 71/02; B01D 69/12; B01D 71/52; B01D 71/40

(52) U.S. Cl. CPC B01D 71/021; B01D 69/12; B01D 2325/04; B01D 71/40; B01D 2325/02; B01D 71/52

(57) ABSTRACT

Described herein is a composite comprising a graphene material and a sulfonated polymer material. The graphene/sulfonated polymer composite is coated onto a substrate to provide a selectively permeable membrane. The selectively permeable membranes of the present disclosure provide high moisture permeability and low gas permeability.

### CROSS-REFERENCE TO RELATED APPLICATIONS

This application claims the benefit of U.S. Provisional Application No. 62/666,044, filed May 2, 2018, and U.S. Provisional Application No. 62/688,308, filed Jun. 21, 2018.

### FIELD

The present embodiments are related to polymeric membranes, and provide a membrane including graphene materials for removing water or water vapor from air or other gas streams.

### BACKGROUND

The presence of high moisture level in the air may contribute to serious health issues by promoting growth of mold, fungus, as well as dust mites. In manufacturing and storage facilities, a high humidity environment may accelerate product degradation, powder agglomeration, seed germination, corrosion, and other undesired effects in chemical, pharmaceutical, food and electronic industries. A conventional method to dehydrate air is passing wet air through hydroscopic agents, such as glycol, silica gel, molecular sieves, calcium chloride, and phosphorous pentoxide. This method has the disadvantage of having to replace or regenerate the drying agent periodically, making the dehydration process costly and time consuming. Another method of dehydration of air is a cryogenic method involving compressing and cooling the wet air to condense moisture which is then removed. However, this method is highly energy consuming.

Compared with traditional dehumidification technologies, membrane-based gas dehumidification technology has distinct technical and economic advantages.

Graphene materials have many attractive properties, such as a 2-dimensional sheet-like structure with extraordinary high mechanical strength and nanometer scale thickness. Graphene oxide, an exfoliated oxidation product of graphite, may be mass produced at low cost. With its high degree of oxidation, graphene oxide has high water permeability and may easily be functionalized in a variety of different ways. Due to their versatility, graphene materials have potential as dehydration membranes.

### SUMMARY

The present embodiments include membranes comprising a sulfonated polymer and graphene material which may reduce water swelling and improve H₂O/gas selectivity over neat non-sulfonated polymer membranes. Some embodiments may provide an improved dehydration membrane compared with traditional polymer (e.g., PVA) membranes. The present embodiments include a selectively permeable element that is useful in applications where it is desirable to minimize gas permeability, while concurrently enabling fluid or water vapor to pass through.

Some embodiments include a selectively permeable membrane, such as a dehydration membrane comprising: a support; a composite comprising a graphene compound (such as a graphene oxide compound), and a sulfonated polymer, wherein the sulfonated polymer can be selected from sulfonated polyvinyl alcohol (s-PVA), sulfonated polyacrylic acid (s-PAA), sulfonated polyether ether ketone (s-PEEK), and sulfonated polystyrene (s-PS); and wherein the composite is coated on the support. In some embodiments, the membrane has a high moisture permeability and low gas permeability.

Some embodiments include a method for making a moisture permeable and/or gas barrier element. The method can comprise mixing a sulfonated polymer and a graphene compound, such as a graphene oxide compound, in an aqueous mixture.

Some embodiments include a method of separating a particular gas from a mixture of gases, or dehydrating a gas, comprising applying a pressure gradient (including a partial pressure gradient for the particular gas) across the selectively permeable membrane, such as a dehydration membrane, to cause the particular gas, such as water vapor, to selectively pass through the dehydration membrane, wherein a first gas applies a higher pressure, or a higher partial pressure of the particular gas to be separated, to a first side of the membrane than a pressure applied by a second gas, or a higher partial pressure of the particular gas to be separated, on the other side of the membrane, so that the particular gas, such as water vapor, passes through the dehydration membrane from the first gas into the second gas.

### BRIEF DESCRIPTION OF THE DRAWINGS

FIG. 1 is a depiction of a possible embodiment of a nanocomposite membrane device that may be used in separation or dehydration applications.

FIG. 2 is a depiction of an embodiment for the process for making a separation/dehydration element and/or device.

### DETAILED DESCRIPTION

The present disclosure relates to gas separation membranes where a high moisture permeability membrane with low gas (e.g., oxygen and/or nitrogen) permeability may be useful to effect dehydration. This membrane material may be suitable in the dehumidification of air, oxygen, nitrogen, hydrogen, methane, propylene, carbon dioxide, natural gas, methanol, ethanol, and/or isopropanol. Some embodiments include a moisture permeable GO-sulfonated polymer membrane composition, and the membrane may have a high H₂O/air selectivity. These embodiments may have improved energy and separation efficiency.

A moisture permeable and/or gas impermeable barrier element may contain a composite, such as a composite comprising a graphene material dispersed in a polymer. This composite may be coated on a support material. The graphene material may be a graphene oxide material. The polymer may be a sulfonated polymer.

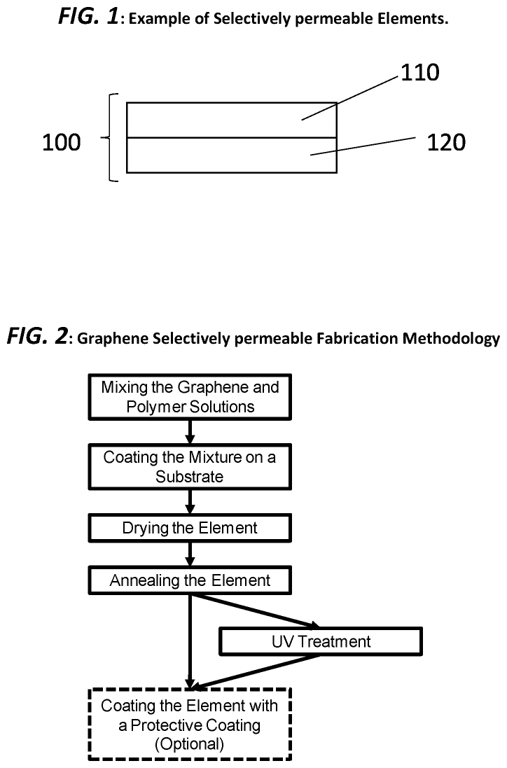

For example, as shown in FIG. 1, a selectively permeable membrane 100 (such as a dehydration membrane), may comprise: a support 120 and a composite 110. Composite 110 may be coated onto support 120.

In some embodiments, the support, e.g. support 120, is porous. In some embodiments, the support may be polymeric. In some embodiments, the support can comprise polypropylene, polyethylene terephthalate, polysulfone, polyether sulfone, polyamide, polyvinylidene fluoride, cellulose, cellulose acetate or polyether sulfone, or any combination or mixture thereof. In other embodiments, the support may comprise polypropylene or stretched polypropylene.

A composite, such as composite 110, comprises a graphene compound and a sulfonated polymer. A graphene material may contain a graphene which has been chemically modified or functionalized. A modified graphene may be any graphene material that has been chemically modified, such as oxidized graphene or functionalized graphene. Oxidized graphene includes graphene oxide or reduced graphene oxide. One possible depiction of graphene oxide is pictured below.

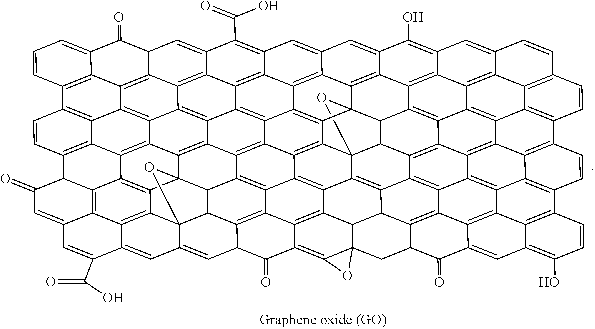 [SMILES: O=C(O)c1cc2c3c4c5c6c7c3c1=CC1=CC3C(=O)C8=C9OC9%10CC9C(=O)c%11cc%12c(O)ccc%13c%14ccc%15c%16ccc%17ccc%18cc%19c(O)c%20cc%21cc%22c(C(=O)O)c%23c%24c%25c%26c%27c%28c(cccc%28c%28ccc(c%29c-5c5c%30c%31c%32c%33c%34c(c8c8c%35c%34c%34c%36c%37c%38c(c%21c%21c%20c%20c%39c%40c%41c%42c%43c%44c(c%11c(c%12%13)c%11c%44c%41c(c%15c%14%11)c%11c%16c%17c%18c(c%19%20)c%40%11)=C9C(C%43=C%35C%369OC%21%37C%39C%429)C8%10)c%22c%24c(c%38c%34%32)c%31c%25c5c%27c%29%28)=C3C3C%33C6%30OC173)C4C(=O)C=2)C(=O)C%26C=%23]

Functionalized graphene includes one or more functional groups not present in graphene oxide, such as functional groups that are not OH, COOH or an epoxide group directly attached to a C-atom of the graphene base. Examples of functional groups that may be present in functionalized graphene include halogen, alkene, alkyne, CN, ether, ester, amide, or amine.

In some embodiments, more than about 99%, more than about 95%, more than about 90%, more than about 80%, more than about 70%, more than about 60%, more than about 50%, more than about 40%, more than about 30%, more than about 20%, more than about 10%, or more than about 5% of the graphene molecules may be oxidized or functionalized.

In some embodiments, the graphene material is graphene oxide, which may provide selective permeability for gases, fluids, and/or vapors. In some embodiments, the selectively permeable element may comprise multiple layers, wherein at least one layer contains graphene material.

It is believed that there may be a large number (˜30%) of epoxy groups on GO, which may be readily reactive with hydroxyl groups at elevated temperatures. It is also believed that a GO sheet has an extraordinary high aspect ratio. This high aspect ratio may increase the available gas diffusion surface if dispersed in a polymeric membrane, e.g., sulfonated PVA membrane. Therefore, sulfonated PVA cross-linked with GO may not only reduce the water swelling of the membrane, but also increase the membrane gas separation efficiency. It is also believed that the epoxy or hydroxyl groups increase the hydrophilicity of the materials, and thus contribute to the increase in water vapor permeability and selectivity of the membrane.

In some embodiments, the graphene material may be in the form of sheets, planes or flakes. In some embodiments, the graphene material may be in the shape of platelets. In some embodiments, the graphene may have a platelet size of about 0.05-100 μm, about 0.05-1 μm, about 0.1-50 μm, about 0.5-10 μm, about 1-5 μm, about 0.1-2 μm, about 1-3 μm, about 2-4 μm, about 3-5 μm, about 4-6 μm, about 5-7 μm, about 6-8 μm, about 7-10 μm, about 10-15 μm, about 15-20 μm, about 50-100 μm, about 60-80 μm, about 50-60 μm, about 25-50 μm, or any platelet size in a range bounded by any of these values.

In some embodiments, the graphene may have a platelet surface area of about 0.1-50,000 μm², about 10-500 μm², about 500-1,000 μm², about 1,000-1,500 μm², about 1,500-2,000 μm², about 2,000-2,500 μm², about 2,500-3,000 μm², about 3,000-3,500 μm², about 3,500-4,000 μm², about 4,000-4,500 μm², about 4,500-5,000 μm², about 5,000-6,000 μm², about 6,000-7,000 μm², about 7,000-8,000 μm², about 8,000-9,000 μm², about 9,000-10,000 μm², about 10,000-20,000 μm², about 20,000-50,000 μm², or about 2500 μm² per platelet, or any surface area in a range bounded by any of these values.

In some embodiments, the graphene material may have a surface area of about 100 m²/g to about 5000 m²/g, about 150 m²/g to about 4000 m²/g, about 200 m²/g to about 1000 m²/g, about 400 m²/g to about 500 m²/g, or about any surface area of graphene material in a range bounded by, or between, any of these values.

A moisture permeable and/or gas impermeable barrier element may contain graphene material dispersed in a sulfonated polymer. For example, the graphene material, such as a graphene oxide, may be dispersed in a sulfonated polymer, such as sulfonated polyvinyl alcohol, in the form of a composite. The graphene material, e.g. a graphene oxide, and the sulfonated polymer, e.g. sulfonated polyvinyl alcohol, may be covalently bonded or cross-linked to one another.

Structures associated with some of the sulfonated polymers referred to herein are depicted below:

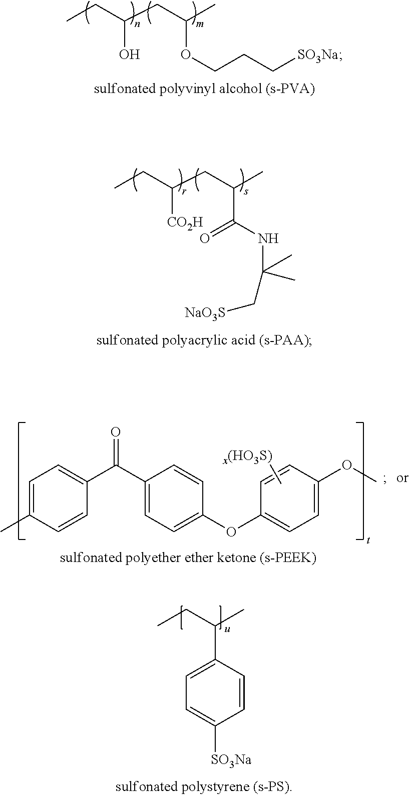

When the polymer is sulfonated polyvinyl alcohol, the molecular weight may be about 250-1,000,000 Da, about 250-1,000 Da, about 1,000-10,000 Da, about 10,000-500,000 Da, about 500,000-1,000,000 Da, about 10,000-50,000 Da, about 50,000-70,000 Da, about 70,000-90,000 Da, about 90,000-110,000 Da, about 110,000-130,000 Da, about 130,000-150,000 Da, about 150,000-170,000 Da, about 170,000-190,000 Da, about 190,000-210,000, about 63,000 Da, about 190,000 Da, about 98,000 Da, or any molecular weight in a range bounded by any of these values.

When the polymer is sulfonated polyacrylic acid, the molecular weight may be about 300-1,000,000 Da, about 300-1,000 Da, about 1,000-10,000 Da, about 10,000-500,000 Da, about 500,000-1,000,000 Da, about 10,000-60,000 Da, about 50,000-80,000 Da, about 80,000-110,000 Da, about 110,000-150,000 Da, about 150,000-200,000 Da, about 200,000-250,000 Da, about 250,000-300,000 Da, about 300,000-350,000 Da, about 350,000-400,000 Da, about 400,000-450,000, about 450,000-500,000, about 95,000 Da, about 450,000 Da, about 200,000 Da, or any molecular weight in a range bounded by any of these values.

When the polymer is sulfonated poly(ether ether ketone), the molecular weight may be about 500-120,000 Da, about 500-1,000 Da, about 1,000-5,000 Da, about 5,000-10,000 Da, about 10,000-20,000 Da, about 20,000-30,000 Da, about 30,000-40,000 Da, about 40,000-50,000 Da, about 50,000-60,000 Da, about 60,000-70,000 Da, about 70,000-80,000 Da, about 80,000-90,000 Da, about 90,000-100,000 Da, about 100,000-110,000 Da, about 110,000-120,000, about 25,000 Da, about 33,000 Da, about 13,000 Da, about 16,000 Da, or any molecular weight in a range bounded by any of these values.

When the polymer is sulfonated poly(sodium 4-styrenesulfonate), the molecular weight may be about 500-1,000,000 Da, about 500-1,000 Da, about 1,000-10,000 Da, about 10,000-500,000 Da, about 500,000-1,000,000 Da, about 10,000-50,000 Da, about 50,000-70,000 Da, about 70,000-90,000 Da, about 90,000-110,000 Da, about 110,000-130,000 Da, about 130,000-150,000 Da, about 150,000-170,000 Da, about 170,000-190,000 Da, about 190,000-210,000, about 70,000 Da, about 200,000 Da, about 1,000,000 Da, or any molecular weight in a range bounded by any of these values.

In some embodiments, the graphene material may be arranged in the sulfonated polymer material in such a manner as to create an exfoliated nanocomposite, an intercalated nanocomposite, or a phase-separated micro-composite. A phase-separated micro-composite may be generated when, although mixed in the sulfonated polymer, the graphene material exists as a separate and distinct phase apart from the sulfonated polymer. An intercalated nanocomposite may be produced when the sulfonated polymer compounds begin to intermingle among or between the graphene platelets but the graphene material may not be distributed throughout the sulfonated polymer. In an exfoliated nanocomposite phase, the individual graphene platelets may be distributed within or throughout the sulfonated polymer. An exfoliated nanocomposite phase may be achieved by chemically exfoliating the graphene material by a modified Hummer's method. In some embodiments, the majority of the graphene material may be staggered to create an exfoliated nanocomposite as a dominant material phase. In some embodiments, the graphene material may be separated by about 10 nm, about 50 nm, about 100 nm to about 500 nm, or about 100 nm to about 1 micron (μm).

The graphene material (e.g. graphene oxide)/sulfonated polymer (for example s-PVA, s-PAA, s-PEEK or s-PS) composite may be in the form of a film, such as a thin film having a thickness of about 0.1-1000 μm, about 0.1-400 μm, about 0.1-20 μm, about 0.1-0.5 μm, about 0.5-2 μm, about 1-3 μm, about 2-4 μm, about 3-5 μm, about 4-6 μm, about 6-8 μm, about 8-10 μm, about 10-12 μm, about 12-15 μm, about 15-20 μm, about 20-30 μm, about 30-50 μm, about 1.4 μm, about 3 μm, about 5 μm, about 10 μm, or any thickness in a range bounded by any of these values.

In some embodiments, the weight ratio of the graphene oxide relative to the sulfonated polymer (for example s-PVA, s-PAA, s-PEEK or s-PS) is about 0.1:100 to about 1:10. In some examples, the weight percentage of graphene oxide relative to the sulfonated polymer is about 0.1-0.5 wt %, about 0.5-1 wt %, about 1-2 wt %, about 2-3 wt %, about 3-4 wt %, about 4-5 wt %, about 5-6 wt %, about 6-7 wt %, about 7-8 wt %, about 8-9 wt %, about 9-10 wt %, about 1 wt %, about 2 wt %, about 3 wt %, about 3.3 wt %, or any percentage in a range bounded by any of these values.

Graphene oxide may be cross-linked to a sulfonated polymer (for example s-PVA, s-PAA, s-PEEK or s-PS), e.g. by one or more ester, sulfoester, sulfonyl, or ether bonds. In some embodiments, at least about 1%, about 5%, about 10%, about, 20%, about 30%, about 40%, about 50%, about 60%, about 70%, about 80%, about 90%, about 95% or 100% of the graphene oxide molecules are cross-linked.

In some embodiments, e.g., when the polymer material is s-PVA, s-PAA, s-PEEK or s-PS, the graphene material and the sulfonated polymer material may be cross-linked by applying heating between about 50° C. to about 125° C., for a period of about 5 minutes to about 4 hours, e.g., at 90° C. for about 30 minutes or at 85° C. for about 30 minutes. In some embodiments, the graphene material and the polymer material may be cross-linked without an additional cross-linker material by sufficient exposure to an ultraviolet radiation.

A membrane described herein may be selectively permeable. For example, the membrane may be relatively permeable for one material and relatively impermeable for another material. For example, a membrane may be relatively permeable to water vapor and relatively impermeable to oxygen and/or nitrogen gas. The ratio of permeability of the different materials may be used to quantify the selective permeability.

In some embodiments, the membrane may be a dehydration membrane. For example, the membrane may dehydrate a gas such as air, oxygen, nitrogen, hydrogen, methane, propylene, carbon dioxide, natural gas, etc. Some membranes may separate other gases from one another.

In some embodiments, the membrane may have low gas permeability, such as less than 0.1 cc/m²·day, less than 0.01 cc/m²·day, less than 0.05 cc/m²·day, and/or less than 0.005 cc/m²·day. In some embodiments, a suitable method for determining gas permeability is ASTM D3985, ASTM F1307, ASTM 1249, ASTM F2622, and/or ASTM F1927. In some embodiments, the gas permeability may be less than 1×10⁻⁵ L/m²·s·Pa. In some embodiments the gas permeability may be less than 5×10⁻⁶ L/m²·s·Pa, less than 1×10⁻⁶ L/m²·s·Pa, less than 5×10⁻² L/m²·s·Pa, less than 1×10⁻² L/m²·s·Pa, less than 5×10⁻⁸ L/m²·s·Pa, less than 1×10⁻⁸ L/m²·s·Pa, less than 5×10⁻⁹ L/m²·s·Pa, or less than 1×10⁻⁹ L/m²·s·Pa. In some examples, a suitable method of determining gas permeability can be ASTM D-727-58, TAPPI-T-536-88 standard method, and/or ASTM 6701.

In some embodiments, the membrane has relatively high water vapor permeability. In some examples, the moisture permeability may be greater than 500 g/m² day or greater than 1×10⁻⁵ L/m²·s·Pa. In some embodiments, the water vapor permeance is greater than about 1-2×10⁻⁵ L/m²·s·Pa, about 2-3×10⁻⁵ L/m²·s·Pa, about 3-4×10⁻⁵ L/m²·s·Pa, about 4-5×10⁻⁵ L/m²·s·Pa, about 5-6×10⁻⁵ L/m²·s·Pa, about 6-7×10⁻⁵ L/m²·s·Pa, about 7-8×10⁻⁵ L/m²·s·Pa, about 8-9×10⁻⁵ L/m²·s·Pa, about 9-10×10⁻⁵ L/m²·s·Pa, about 10-11×10⁻⁵ L/m²·s·Pa, about 11-15×10⁻⁵ L/m²·s·Pa, about 15-20×10⁻⁵ L/m²·s·Pa, or any value bound by any of these ranges. In some embodiments, the moisture permeability may be a measure of water vapor permeability/transfer rate at the above described levels. Suitable methods for determining moisture (water vapor) permeability are disclosed in ASTM D7709, ASTM F1249, ASTM 398 and/or ASTM E96.

In some embodiments, the selective permeability may be reflected in a ratio of permeabilities of water vapor and at least one selected gas, e.g., oxygen and/or nitrogen, permeabilities. In some embodiments, the membrane may exhibit a water vapor permeability:gas permeability ratio, of greater than 5, greater than 50, greater than 100, greater than 200, greater than 500, greater than 1,000, greater than 5,000, greater than 10,000, greater than 20,000, or greater than 30,000. In some embodiments, the selective permeability may be a measure of water vapor:gas permeability/transfer rate ratios at the above described levels. Suitable methods for determining water vapor permeability and/or gas permeability have been disclosed above.

A high water or moisture permeable membrane is described herein, and the membrane comprises: a support; a composite comprising a graphene oxide compound and a sulfonated polymer, wherein the sulfonated polymer may be selected from sulfonated polyvinyl alcohol, sulfonated polyacrylic acid, sulfonated polyether ether ketone, and sulfonated polystyrene; and the composite optionally further comprises non-sulfonated polymers, cross-linking elements, surfactants, dispersants, binders, alkali metal halides, alkaline earth metal halides, and solvents. In some embodiments, the composite may coat the support. In some embodiments, the membrane can have a high moisture permeability and low gas permeability. In some embodiments, the graphene oxide and sulfonated polymer can be cross-linked

In some examples, the composite comprising graphene oxide and a sulfonated polymer further comprises a non-sulfonated polymer. In some embodiments, the non-sulfonated polymer is polyvinyl alcohol (PVA). In some cases, the non-sulfonated polymer is polyacrylic acid (PAA). In some embodiments, the non-sulfonated polymer is present in a weight percentage relative to the weight of the GO/sulfonated polymer/non-sulfonated polymer composite of about 30-70 wt %, about 30-40 wt %, about 40-50 wt %, about 50-60 wt %, about 60-70 wt %, about 70-80 wt %, about 80-90 wt %, about 50 wt %, about 53%, about 70 wt %, or about any weight percentage bounded by any of these ranges.

In some embodiments, the composite further comprises an additional cross-linking element. In some embodiments, the additional cross-linking element can be potassium tetraborate (KBO) and/or sodium lignosulfate (LSU). In some embodiments, the additional cross-linking element is present in the composite in a weight percentage of about 1-30 wt %, about 1-5 wt %, about 5-10 wt %, about 10-15 wt %, about 15-20 wt %, about 20-25 wt %, about 25-30 wt %, about 30-35 wt %, about 35-40 wt %, about 40-50 wt %, about 7 wt %, about 10 wt %, about 18 wt %, about 30 wt %, or about any weight percentage bounded by any of these ranges.

In some embodiments, the composite can further comprise a surfactant. In some embodiments, the surfactant can be sodium lauryl sulfate. In some embodiments, the surfactant can be sodium lignosulfate (LSU). In some embodiments, the surfactant is present in the composite in a weight percentage of about 0.1-4 wt %, about 0.1-0.5 wt %, about 0.5-1 wt %, about 1-1.5 wt %, about 1.5-2 wt %, about 2-2.5 wt %, about 2.5-3 wt %, about 3-3.5 wt %, about 3.5-4 wt %, about 4-10 wt %, about 10-15 wt %, about 15-20 wt %, about 20-25 wt %, about 25-30 wt %, about 30-35 wt %, about 35-40 wt %, 40-50 wt %, about 0.3 wt %, about 0.4 wt %, about 1.9 wt %, about 2 wt %, or about any weight percentage bounded by any of these ranges.

In some embodiments, the composite may comprise a dispersant. In some embodiments, the dispersant may be an ammonium salt, e.g., NH₄Cl; Flowlen; fish oil; a long chain polymer; steric acid; oxidized Menhaden Fish Oil (MFO); a dicarboxylic acid, such as but not limited to succinic acid, ethanedioic acid, propanedioic acid, pentanedioic acid, hexanedioic acid, heptanedioic acid, octanedioic acid, nonanedioic acid, decanedioic acid, o-phthalic acid, and p-phthalic acid; sorbitan monooleate; and mixtures thereof. Some embodiments preferably use oxidized MFO as a dispersant.

In some embodiments, the composite may further comprise a binder (such as an additional cross-linker compound or an adhesive compound). In some embodiments, the binder may be lignin analogues. In some embodiments, the binder may be a lignosulfonate, such as potassium lignosulfonate. In some embodiments, the binder may be potassium tetraborate (KBO).

In some embodiments, the composite can further comprise an alkali metal halide. In some embodiments, the alkali metal can be lithium. In some embodiments, the halide can be chloride. In some embodiments, the alkali metal halide is lithium chloride. In some embodiments, the alkali halide can be present in the composite in a weight amount between about 1 wt % to about 50 wt %, about 1-10 wt %, about 10-20 wt %, about 20-30 wt %, about 30-40 wt %, about 40-50 wt %, about 18 wt %, about 21 wt %, about 23 wt %, about 30.0% wt, or any weight amount bounded by any of these ranges.

In some embodiments, the composite can further comprise an alkaline earth metal halide. In some embodiments, the alkaline earth metal is calcium. In some embodiments, the alkaline earth metal halide is chloride. In some examples, the alkaline earth metal halide is calcium chloride. In some cases, the alkaline earth metal halide can be present in the composite in a weight amount between about 1 wt % to about 50 wt %, about 1-10 wt %, about 10-20 wt %, about 20-30 wt %, about 30-40 wt %, about 40-50 wt %, about 23 wt %, about 30.0% wt, or any weight amount bounded by any of these ranges.

In some embodiments, solvents may also be present in the selectively permeable element. Used in manufacture of graphene material composite layers, solvents include, but are not limited to, water, a lower alkanol such as but not limited to ethanol, methanol, isopropyl alcohol, xylenes, cyclohexanone, acetone, toluene and methyl ethyl ketone, and mixtures thereof. Some embodiments include a method for creating the aforementioned selectively permeable element. In some embodiments, graphene is mixed with a sulfonated polymer solution to form an aqueous mixture. In some embodiments the graphene is in an aqueous solution form. In some embodiments, the sulfonated polymer comprises a sulfonated polymer in an aqueous solution. In some embodiments, two solutions are mixed, the mixing ratio may be between about 0.1:100-1:10, about 1:10-1:4, about 1:4-1:2, about 1:2-1:1, about 1:1-2:1, about 2:1-4:1, about 4:1-9:1, or about 9:1-10:1 parts graphene solution to polymer solution by weight or volume. Some embodiments preferably use a mixing ratio of about 1:1. Some embodiments preferably use a mixing ratio of about 1:4. In some embodiments, in addition to the two solutions, an additional cross-linker solution is also added. In some embodiments, the graphene and sulfonated polymer are mixed such that the dominant phase of the mixture comprises exfoliated nanocomposites. One potential reason for using the exfoliated-nanocomposites phase is that it is believed that in this phase the graphene platelets are aligned such that gas permeability is reduced in the finished film by elongating the possible molecular pathways through the film. In some embodiments, the graphene composition may comprise any combination of the following: graphene, graphene oxide, and/or functionalized graphene oxide. In some embodiments, the amount of graphene material in the entire graphene/sulfonated polymer aqueous solution composition is about between about 0.01 wt % and about 10.0% wt. Some embodiments use a graphene concentration of about 0.76 wt % of the solution (e.g., Ex-1 below, with a ratio of 1/100/30 of GO/s-PVA/LiCl). In some embodiments the sulfonated polymer aqueous solution may comprise a sulfonated polymer in about a 1% to about 15% aqueous solution. Some embodiments preferably use about a 4% aqueous solution.

Some embodiments include a membrane is. In some embodiments, the membrane may be selectively permeable. In some embodiments, the membrane can be high water or moisture permeable. In some embodiments, the membrane may be a dehydration membrane. In some embodiments, the membrane may be an air dehydration membrane. In some embodiments, the membrane may be a gas separation membrane. In some embodiments, a moisture permeable-and/or-gas impermeable barrier element containing graphene material, e.g., graphene oxide, may provide desired selective gas, fluids, and/or vapor permeability resistance. In some embodiments, the selectively permeable element may comprise multiple layers, where at least one layer is a layer containing graphene material.

In some embodiments, the selectively permeable element comprises a support and a composite coating the support material. In some embodiments, the membrane has a relatively high water vapor permeability. In some embodiments, the membrane may have a low gas permeability. In some embodiments, the support may be porous. In some embodiments the composite material may comprise a graphene material and a polymer material. In some embodiment, the graphene material and the polymer material are covalently linked to one another. In some embodiments, the graphene material may be arranged amongst the polymer material. In some embodiments, the selectively permeable element further comprises a cross-linker material or a cross-linking group that results from reacting the cross-linker material.

In some embodiments, the selectively permeable element may be disposed between or separate a fluidly communicated first fluid reservoir and a second fluid reservoir. In some embodiments, the first reservoir may contain a feed fluid upstream and/or at the selectively permeable element. In some embodiments, the second reservoir may contain a processed fluid downstream and/or at the selectively permeable element. In some embodiments, the selectively permeable element selectively allows undesired water vapor to pass therethrough while retaining or reducing the passage of another gas or fluid material from passing therethrough. In some embodiments, the selectively permeable element may provide a filter element to selectively remove water vapor from a feed fluid while enabling the retention of processed fluid with substantially less undesired water or water vapor. In some embodiments, the selectively permeable element has a desired flow rate. In some embodiments, the selectively permeable element exhibits a flow rate of about 0.001-0.1 liter/min; about 0.005-0.075 liter/min; or about 0.01-0.05 liter/min, for example at least about 0.005 liter/min., at least about 0.01 liter/minute, at least about 0.02 liter/min, at least about 0.05 liter/min, about 0.1 liter/min, about 0.5 liter/min, about 1.0 liter/min, or any flow rate of the selectively permeable element in a range bounded by, or between, any of these values.

In some embodiments, the selectively permeable element may comprise an ultrafiltration material. In some embodiments, the selectively permeable element comprises a filter having a molecular weight of at least 70%, at least 75%, at least 80%, at least 85%, at least 90%, at least 95%, at least 97% at least 99% of 5000-200,000 Daltons. In some embodiments, the ultrafiltration material or a membrane containing such material may have an average pore size or fluid passageway of about 0.01 μm (10 nm) to about 0.1 μm (100 nm), or about 0.01 μm (10 nm) to about 0.05 μm (50 nm) in average diameter. In some embodiments, the membrane surface area is about: 0.01 m², 0.05 m², 0.1 m², 0.25 m², or 0.35 m² to about: 0.5 m², 0.6 m², 0.7 m², 0.75 m², or 1 m²; 1.5-2.5 m²; at least about: 5 m², 10 m², 15 m², 20 m², 25 m², 30 m², 40 m², 50 m², 60 m², about 65-100 m², about 500 m², or any membrane surface area in a range bounded by, or between, any of these values.

In some embodiments, the graphene material may be arranged in the sulfonated polymer material in such a manner as to create an exfoliated nanocomposite, an intercalated nanocomposite, or a phase-separated microcomposite. A phase-separated microcomposite phase may occur when, although mixed, the graphene material exists as separate and distinct phases apart from the sulfonated polymer. An intercalated nanocomposite may occur when the sulfonated polymer compounds begin to intermingle amongst or between the graphene platelets but the graphene material may not be distributed throughout the sulfonated polymer. In an exfoliated nanocomposite phase the individual graphene platelets may be distributed within or throughout the sulfonated polymer. An exfoliated nanocomposite phase may be achieved by chemically exfoliating the graphene material by a modified Hummer's method, a process well known to persons of ordinary skill and as detailed in the Examples below. It is believed that this modified Hummer's methodology is useful in providing appropriately sized graphene oxide sheets for use in the present disclosure.

In some embodiments, the polymer material may comprise any combination of sulfonated alkyl and sulfonated aryl polymers and biopolymers. In some embodiments, the sulfonated polymer can be functionalized with a XO₃S functional group, wherein X can be Na, K, or H. In some embodiments, sulfonated alkyl polymers may include but are not limited to sulfonated polyvinyl alcohol (s-PVA) and sulfonated polyacrylic acid (s-PAA), and mixtures thereof. In some embodiments, the vinyl polymer may comprise s-PVA. In some embodiments, the sulfonated aryl polymer can comprise a sulfonated aryl ketone. In some embodiments, the polymer material can comprise sulfonated polyether ether ketone (s-PEEK). It is believed that the sulfonation of the monomers provides a desired level of hydrophilicity to the membrane. It is also believed that the polymer component of the membrane provides a desired level of water vapor permeability, e.g., the membrane can have a water vapor permeability of at least about 0.5×10⁻⁵ g/m² s Pa, at least about 1.0×10⁻⁵ g/m² s Pa, at least about 1.5×10⁻⁵ g/m² s Pa, at least about 2.0×10⁻⁵ g/m² s Pa, at least about 2.5×10⁻⁵ g/m² s Pa, at least about 3.0×10⁻⁵ g/m² s Pa, at least about 3.5×10⁻⁵ g/m² s Pa, at least about 4.0×10⁻⁵ g/m² s Pa, at least about 4.5×10⁻⁵ g/m² s Pa, and/or 5.0×10⁻⁵ g/m² s Pa. In some embodiments, the sulfonated polymers can be selected from:

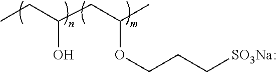

(sulfonated polyvinyl alcohol [s-PVA]), wherein n and/or m can be [n: 1,000 to 3,000; m: 100 to 300; n/m: from 20:1 to 5:1];

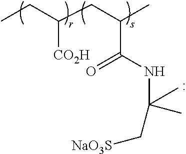

(sulfonated polyacrylic acid [s-PAA])), wherein r and/or s can be [r: 1,000 to 3,000; s: 100 to 1,000; r/s: from: 20:1 to 5:1];

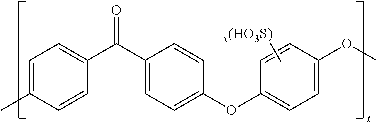

(sulfonated polyether ether ketone [s-PEEK]), wherein t can be 50 to 100; x: 1 to 4;

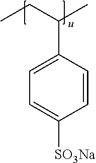

(sulfonated polystyrene [s-PS], also known as poly(sodium 4-styrenesulfonate), wherein u can be 100 to 5,000).

The membranes and elements of the present disclosure may be fabricated using the methodology depicted in FIG. 2. The steps shown in FIG. 2 are described in detail below.

In some embodiments, the GO/sulfonated polymer composite comprises an aqueous solution of about 20 wt % to about 80 wt % sulfonated polymer (relative to the other non-aqueous components of the composite mixture). In some embodiments, the sulfonated polymer material comprises an aqueous solution of about 20-30 wt %, about 30-40 wt %, about 40-50 wt %, about 50-60 wt %, about 60-70 wt %, about 70-80 wt %, about 23 wt %, about 29 wt %, about 30 wt %, about 38 wt %, about 50% wt %, about 61 wt %, about 71 wt % or about 76 wt % sulfonated polymer.

In some embodiments, the graphene material and the sulfonated polymer material may be cross-linked using a cross-linker material. In some embodiments, the graphene material and the sulfonated polymer material may be cross-linked by thermal reaction, and/or UV irradiation. In some embodiments, the graphene material and the sulfonated polymer material may be cross-linked without an additional cross-linker material by heating the materials to a sufficient temperature to thermally cross-link the materials. In some embodiments, e.g., when the sulfonated polymer material may be sulfonated polyvinyl alcohol, the graphene material and the sulfonated polymer material may be cross-linked by applying between about 50° C. to about 125° C., for a period of between 5 minutes and 4 hours, e.g., 90° C. for about 30 minutes. In some embodiments, the graphene material and the sulfonated polymer material may be cross-linked without an additional cross-linker material by sufficient exposure to ultraviolet irradiation.

In some embodiments, the same types of cross-linker materials are used to cross-link the graphene material, the sulfonated polymer material or both the graphene and polymer material, e.g., the same type of cross-linker materials may covalently link the graphene material and the sulfonated polymer material; and/or the sulfonated polymer material with itself or other polymer materials. In some embodiments, the same cross-linker material is used to cross-link the graphene material as well as the sulfonated polymer material.

In some embodiments, graphene can be mixed with a polymer solution and an alkaline earth metal halide to form an aqueous mixture. In some embodiments, the alkaline earth metal can be calcium. In some embodiments, the halide can be chloride. In some embodiments, the alkaline earth metal halide salt can be CaCl₂. In some embodiments the alkaline earth metal halide can be added in the form of an aqueous solution of between about 1% wt to about 50% wt, e.g., about 30% wt.

In some embodiments, the mixture may be blade coated on a substrate to create a thin film between about 1 μm to about 30 μm, e.g., may then cast on a substrate to form a partial element. In some embodiments, the mixture may be disposed upon the substrate—which may be permeable, non-permeable, porous, or non-porous—by spray coating, dip coating, spin coating and/or other methods for deposition of the mixture on a substrate known to those skilled in the art. In some embodiments, the casting may be done by co-extrusion, film deposition, blade coating or any other method for deposition of a film on a substrate known to those skilled in the art. In some embodiments, the mixture is cast onto a substrate by blade coating (or tape casting) by using a doctor blade and dried to form a partial element. The thickness of the resulting cast tape may be adjusted by changing the gap between the doctor blade and the moving substrate. In some embodiments, the gap between the doctor blade and the moving substrate is in the range of about 0.002 mm to about 1.0 mm. In some embodiments, the gap between the doctor blade and the moving substrate is preferably between about 0.20 mm to about 0.50 mm. Meanwhile, the speed of the moving substrate may have a rate in the range of about 30 cm/min. to about 600 cm/min. By adjusting the moving substrate speed and the gap between the blade and moving substrate, the thickness of the resulting graphene polymer layer may be expected to be between about 5 μm and about 200 μm. In some embodiments, the thickness of the layer may be about 10 μm such that transparency is maintained. The result is a selectively permeable element. In some embodiments, the total thickness of the membrane described herein can be between about 5 μm and about 200 μm. While not wanting to be bound by theory, it is believed that the overall thickness of the membrane can contribute to high thermal conductivity for effective heat transfer.

In some embodiments, after deposition of the graphene layer on the substrate, the selectively permeable element may then be dried to remove the underlying solution from the graphene layer. In some embodiments, the drying temperature may be about at room temperature, or 20° C., to about 120° C. In some embodiments the drying time may range from about 15 minutes to about 72 hours depending on the temperature. The purpose is to remove any water and precipitate the cast form. Some embodiments prefer that drying is accomplished at temperatures of about 90° C. for about 30 minutes.

In some embodiments, the method comprises drying the mixture for about 15 minutes to about 72 hours at a temperature ranging between from about 20° C. to about 120° C. In some embodiments, the dried selectively permeable element may be isothermally crystallized, and/or annealed. In some embodiments, annealing may be done from about 10 hours to about 72 hours at an annealing temperature of about 40° C. to about 200° C. Some embodiments prefer that annealing is accomplished at temperatures of about 100° C. for about 18 hours. Other embodiments prefer annealing done for 16 hours at 100° C.

After annealing, the selectively permeable element may be then optionally laminated with a protective coating layer, such that the graphene layer is sandwiched between the substrate and the protective layer. The method for adding layers may be by co-extrusion, film deposition, blade coating or any other method known by those skilled in the art. In some embodiments, additional layers may be added to enhance the properties of the selectively permeable. In some embodiments, the protective layer is secured to the graphene with an adhesive layer to the selectively permeable element to yield the selectively permeable device. In other embodiments, the selectively permeable element is directly bonded to the substrate to yield the selectively permeable device.

The embodiments disclosed herein may be provided as part of a module or a device into which water vapor (saturated or near saturated) and compressed air are introduced. The module produces a dry pressurized product stream (typically having an oxygen concentration within about 1% of 20.9%) and a low pressure permeate stream. The permeate stream contains a mixture of air and the bulk of the water vapour introduced into the module.

In some embodiments, a method for treating a gas is described. One such method comprises providing a membrane described herein and applying the membrane to a complex mixture having a first gas component comprising water vapor and a second gas component, to remove more of the water vapor component than the second gas component. In some embodiments, the membrane is permeable to water vapor. In some embodiments, the membrane has a water vapor permeability of at least about 0.5×10⁻⁵ g/m²s Pa, about 0.5-1×10⁻⁶ g/m²s Pa, about 1-1.5×10⁻⁶ g/m²s Pa, about 1.5-2×10⁻⁶ g/m²s Pa, about 2-2.5×10⁻⁶ g/m²s Pa, about 2.5-3×10⁻⁶ g/m²s Pa, about 3-3.5×10⁻⁶ g/m²s Pa, about 3.5-4×10⁻⁶ g/m²s Pa, about 4-4.5×10⁻⁶ g/m²s Pa, about 4.5-5×10⁻⁶ g/m²s Pa, or about 5×10⁻⁶ g/m² s Pa. In some embodiments, applying the membrane includes selectively passing water vapor therethrough. In some embodiments, the membrane is impermeable or relatively impermeable to the second gas component. In some embodiments, the membrane has a second gas permeability of less than: about 0.1×10⁻⁶ L/m² s Pa, about 0.1-0.25×10⁻⁶ L/m² s Pa, about 0.25-0.5×10⁻⁶ L/m² s Pa, about 0.5-1×10⁻⁶ L/m² s Pa, about 1×10⁻⁶ L/m² s Pa, about 1×10⁻⁶ g/m²·s·Pa, about 5×10⁻⁶ g/m²·s·Pa, about 7×10⁻⁶ g/m²·s·Pa, about 1×10⁻⁷ g/m²·s·Pa, about 1×10⁻⁸ g/m²·s·Pa, about 1×10⁻⁹ g/m²·s·Pa, or about 1×10⁻¹⁰ g/m²·s·Pa. In some embodiments, the second gas component can comprise air, hydrogen, carbon dioxide, and/or a short chain hydrocarbon. In some embodiments the short chain hydrocarbon can be methane, ethane or propane.

Permeated air or a secondary dry sweep stream may be used to optimize the dehydration process. If the membrane were totally efficient in water separation, all the water or water vapor in the feed stream would be removed, and there would be nothing to sweep it out of the system. As the process proceeds, the partial pressure of the water on the feed or bore side becomes lower and lower, and the pressure on the shell-side becomes higher. This pressure difference tends to prevent additional water from being expelled from the module. Since the object is to make the bore side dry, the pressure difference interferes with the desired operation of the device. A sweep stream may therefore be used to remove the water or water vapor from the feed or bore side, in part by absorbing some of the water, and in part by physically pushing the water out.

If a sweep stream is used, it may come from an external dry source or a partial recycle of the product stream of the module. In general, the degree of dehumidification will depend on the partial pressure ratio of water vapor across the membrane and on the product recovery (the ratio of product flow to feed flow). Better membranes have a high product recovery at low levels of product humidity and/or higher volumetric product flow rates.

The membranes of the present disclosure are easily made at low cost, and may outperform existing commercial membranes in either volumetric productivity or product recovery.

### EMBODIMENTS

Embodiment P1. A dehydration membrane comprising:

a support;

a composite comprising a graphene oxide compound and a sulfonated polymer, wherein the sulfonated polymer comprises sulfonated polyvinyl alcohol, sulfonated polyacrylic acid, sulfonated polyether ether ketone, sulfonated polystyrene, or a combination thereof;

wherein the composite coats the support; and

wherein the membrane has a high moisture permeability and low gas permeability.

Embodiment P2. The membrane of embodiment P1, wherein the support is porous.

Embodiment P3. The membrane of Embodiment P1, wherein the support comprises polypropylene, polyethylene terephthalate, polysulfone, polyether sulfone, or a combination thereof.

Embodiment P4. The membrane of Embodiment P1, wherein the graphene oxide and sulfonated polymer are cross-linked.

Embodiment P5. The membrane of Embodiment P1, where the weight ratio of graphene oxide to sulfonated polyvinyl alcohol is from about 0.1:100 to about 9:1.

Embodiment P6. The membrane of Embodiment P1, wherein the graphene oxide compound comprises graphene oxide, reduced-graphene oxide, functionalized graphene oxide, functionalized reduced-graphene oxide, or a combination thereof.

Embodiment P7. The membrane of Embodiment P1, wherein the graphene has a platelet size from about 0.05 μm to about 100 μm.

Embodiment P8. The membrane of Embodiment P1, where the membrane comprises hollow fibers.

Embodiment P9. The membrane of Embodiment P1, wherein the composite further comprises lithium chloride.

Embodiment P10. The membrane of Embodiment P1, wherein the composite further comprises a surfactant.

Embodiment P11. The membrane of Embodiment P10, wherein the surfactant is sodium lauryl sulfate.

Embodiment P12. A method for treating a gas comprising:
applying a membrane of Embodiments P1-P11 to a complex mixture having a first gas component comprising water vapor and a second gas component, to remove more of the water vapor component than the second gas component.

Embodiment 1. A membrane for dehydration of a gas, comprising:
a support;
a composite comprising a graphene oxide compound and a sulfonated polymer, wherein the sulfonated polymer comprises sulfonated polyvinyl alcohol, sulfonated polyacrylic acid, sulfonated polyether ether ketone, sulfonated polystyrene, or a combination thereof;
wherein the composite is coated on the support; and
wherein the membrane has high moisture permeability and low gas permeability.

Embodiment 2. The membrane of Embodiment 1, wherein the support is porous.

Embodiment 3. The membrane of Embodiment 1 or 2, wherein the support comprises polypropylene, polyethylene terephthalate, polysulfone, polyether sulfone, or a combination thereof.

Embodiment 4. The membrane of Embodiment 1, 2, or 3, wherein the weight ratio of the graphene oxide compound to the sulfonated polymer is about 0.001 to about 0.1.

Embodiment 5. The membrane of Embodiment 1, 2, 3, or 4, wherein the graphene oxide compound and the sulfonated polymer are cross-linked.

Embodiment 6. The membrane of Embodiment 1, 2, 3, 4, or 5, wherein the graphene oxide compound comprises graphene oxide, reduced graphene oxide, functionalized graphene oxide, reduced functionalized graphene oxide, or a combination thereof.

Embodiment 7. The membrane of Embodiment 1, 2, 3, 4, 5, or 6, wherein the graphene oxide compound has a platelet size of about 0.05 μm to about 100 μm.

Embodiment 8. The membrane of Embodiment 1, 2, 3, 4, 5, 6, or 7, wherein the composite further comprises an alkali metal halide or an alkaline earth metal halide.

Embodiment 9. The membrane of Embodiment 8, wherein the alkali metal salt is lithium chloride and the alkaline earth metal halide is calcium chloride.

Embodiment 10. The membrane of Embodiment 8 or 9, wherein the alkali metal halide is lithium chloride and the composite further comprises sodium lignosulfate.

Embodiment 11. The membrane of Embodiment 8 or 9, wherein the alkali metal halide is lithium chloride and the composite further comprises sodium lauryl sulfate.

Embodiment 12. The membrane of Embodiment 1, 2, 3, 4, 5, 6, 7, 8, 9, 10, or 11, further comprising polyvinyl alcohol.

Embodiment 13. The membrane of Embodiment 1, 2, 3, 4, 5, 6, 7, 8, 9, 10, 11, or 12, further comprising polyacrylic acid.

Embodiment 14. The membrane of Embodiment 1, 2, 3, 4, 5, 6, 7, 8, 9, 10, 11, 12, or 13, further comprising sodium lauryl sulfate.

Embodiment 15. The membrane of Embodiment 1, 2, 3, 4, 5, 6, 7, 8, 9, 10, 11, 12, 13, or 14, wherein the composite is coated on the support as a film having a thickness between about 2 μm to about 400 μm.

Embodiment 16. A method of dehydrating a first gas, comprising applying the membrane of Embodiment 1, 2, 3, 4, 5, 6, 7, 8, 9, 10, 11, 12, 13, 14, or 15 to the first gas.

Embodiment 17. The method of Embodiment 16, further comprising applying a water vapor pressure gradient across the membrane to cause water vapor to selectively pass through the membrane, wherein the first gas applies a higher water vapor pressure to a first side of the membrane than a water vapor pressure applied by a second gas to a second side of the membrane, so that water vapor passes through the membrane from the first gas to the second gas.

Embodiment 18. The method of Embodiment 16 or 17, wherein the first gas applies a higher total pressure to the first side of the membrane than a total pressure applied by the second gas to the second side of the membrane.

Embodiment 19. The method of Embodiment 16, 17, or 18, wherein the first gas is air, oxygen, or nitrogen.

Embodiment 20. The method of Embodiment 16, 17, 18, or 19, wherein the membrane has a water vapor permeance of at least 3.2×10⁻⁵ g/m²·s·Pa.

Embodiment 21. The method of Embodiment 16, 17, 18, 19, or 20, wherein the membrane has a gas permeance of at most 7.2×10⁻⁶ g/m²·s·Pa.

### EXAMPLES

It has been discovered that embodiments of the selectively permeable elements described herein have improved permeability resistance to both oxygen gas and vapor with acceptable material properties as compared to other selectively permeable elements. These benefits are further shown by the following examples, which are intended to be illustrative of the embodiments of the disclosure, but are not intended to limit the scope or underlying principles in any way.

### Example 1: Synthesis of Sulfonated PVA (s-PVA)

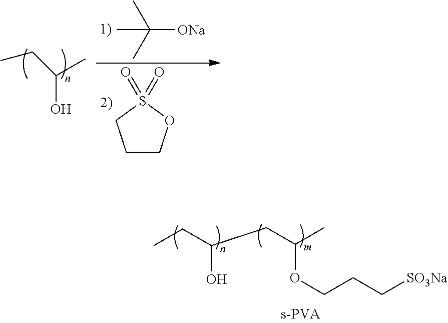

To a solution of polyvinyl alcohol (8.8 g, Mw: 89,000˜98,000) in anhydrous DMSO (50 mL), was added anhydrous sodium tert-butoxide (2.88 g), then was stirred at 90° C. for 1.5 hr to form a viscous orange solution. To the resulting solution, 1,3-propanesultone (2.44 g) in 10 mL DMSO solution was added, and kept stirring at 80° C. for 1.5 hr. After it was cooled to room temperature, the reaction mixture was poured into 400 mL methanol while stirring, then poured into 500 mL isopropanol to have white precipitate formed. Filtration and drying under vacuum to give a light yellow solid, 9.77 g in 87% yield. ¹H NMR (D₂O, 400 MHz): δ 3.99 (m, 11H), 3.60-3.70 (m, 2H), 2.95 (t, 2H), 1.97 (m, 2H), 1.57-1.67 (m, 22H).

### Example 2: Synthesis of Sulfonated PAA (s-PAA)

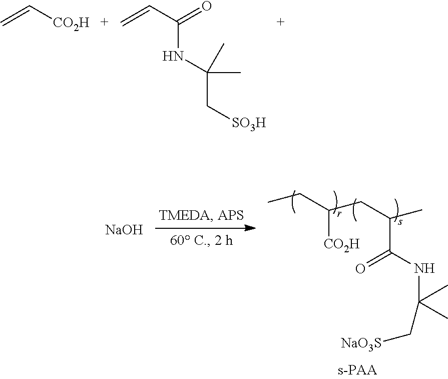

A solution of acrylic acid (14.4 g), 2-acrylamido-2-methyl-1-propanesulfonic acid, sodium hydroxide (0.8 g), N,N,N′N′-tetramethylethylenediamine (0.2 mL) in distilled water (100 mL) was degassed for one hour, then ammonium persulfate (0.1 g) was added and the solution was stirred at 60° C. for 2 hr. After cooling to room temperature, the gel-like solution was dried using freeze-dryer to give 19 g of white solid in quantitative yield. ¹H NMR (D₂O, 400 MHz): δ 3.28 (bs, 1H), 2.32 (m, 11H), 1.58-1.85 (m, 22H), 1.41 (s, 6H).

### Example 3: Synthesis of Sulfonated PEEK (s-PEEK)

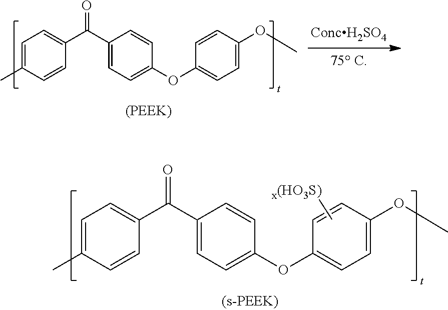

Sulfonated PEEK: A mixture of 5 g poly(oxyl-1,4-phenyleneoxy-1,4-phenylenecarboxyl-1,4-phenylene (PEEK, Mw: 20,800) in 50 mL concentrated sulfuric acid was stirred at 75° C. for 3 days. After cooling to room temperature, the resulting solution was poured into 200 g ice to form a white precipitate. The suspension was stirred overnight, then filtered and washed with 50 mL water. The white solid was collected and dried in vacuum oven at 50° C. for 2 days to afford 10 g of sulfonated PEEK. ¹H NMR (D₂O, 400 MHz): δ 6.2-8.5 (broad m, 8H).

### Example 4: Sulfonated Polystyrene (s-PS)

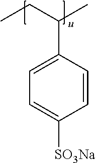

Poly(sodium 4-styrenesulfonate (sulfonated polystyrene) was purchased from Sigma-Aldrich (St. Louis, Mo., USA) and used without additional purification. A 5 wt % solution was made with deionized water (DI).

### Example 5: Preparation of GO/Polymer Membranes

### Example EX-1 (GO/s-PVA/LiCl)

Graphene oxide was prepared from graphite using a modified Hummers' method. Graphite flake (4.0 g, Aldrich 100 mesh) was oxidized in a mixture of NaNO₃ (4.0 g), KMnO₄ (24 g) and concentrated 98% sulfuric acid (192 mL) at 50° C. for 15 hours; then the resulting pasty mixture was poured into ice (800 g) followed by addition of 30% hydrogen peroxide (40 mL). The resulting suspension was stirred for 2 hours to reduce manganese dioxide, then filtered through filter paper and the solid washed with 500 mL of 0.16 N hydrochloric acid aqueous solution then DI water twice. The solid was collected and dispersed in DI water (2 L) by stirring for two days, then sonicated with a 10 watt probe sonicator for 2 hours with ice-water bath cooling. The resulting dispersion was centrifuged at 3000 rpm for 40 min to remove large non-exfoliated graphite oxide. The size of the GO platelets prepared in this manner was approximately 50 μm. The GO platelets prepared in this manner may be diluted with DI water to obtain a desired wt % dispersion of GO.

1 mL of 0.1% GO dispersion (prepared as above) was combined with 6.1 mL water and sonicated for about 3 minutes. After GO is completely dispersed in the water, 4 mL of s-PVA (2.5% aqueous solution) was added to the solution. The solution was sonicated for about 8 minutes. After observing that the s-PVA is completely dissolved in the solution, 0.6 mL of LiCl (5%) (Sigma Aldrich, St. Louis, Mo., USA) is added and the solution is sonicated for about 6 minutes to completely dissolve LiCl in the solution.

### Examples EX-2 Through EX-12

EX-2 to EX-12, as shown in Table 1 below, were made in a manner similar to EX-1, with the following exceptions: (a) different sulfonated polymers could be utilized in place of s-PVA (e.g., s-PAA, s-PEEK, and s-PS), in the amounts or ratios described, (b) optionally other additive materials could be used in place of, or in addition to, LiCl (e.g., LSU, SLS, and CaCl₂) in amounts or ratios described, and (c) optionally additional non-sulfonated polymers could be utilized (e.g., PAA and PVA) in the amounts or ratios described.

Substrate treatment: Porous polypropylene substrate (Celgard 2500) was first subjected to hydrophilic modification with corona treatment using power of 70 W, 3 counts, speed of 0.5 m/min.

### Coating and Curing:

The coating solution was applied on the freshly treated substrate, with 200 μm wet gap. The resulting membrane was dried then cured at 110° C. for 5 min.

### Measurement of Selectively Permeable Elements

EX-1, EX-2, EX-3, EX-4, EX-5, EX-6, EX-7, EX-8, EX-9, EX-10, EX-11, and EX-12, made as described above were tested for nitrogen permeance as described in ASTM 6701, at 23° C. and 0% relative humidity (RH). The results are shown in Table 1.

EX-1, EX-2, EX-3, EX-4, EX-5, EX-6, EX-7, EX-8, EX-9, EX-10, EX-11, and EX-12 made as described above were tested for water vapor transmission rate (WVTR) as described in ASTM E96 standard method, at 20° C. and 100% relative humidity (RH). The results are shown in Table 1.

TABLE 1
Water vapor permeance and N₂ permeance of GO-sulfonated polymer membranes

| | | | | | Water | |
|---|---|---|---|---|---|---|
| | | | | | vapor | N₂ |
| | | | | | Permeance | Permeance |
| EX- | Composition | Ratio (wt/wt) | Thickness | Substrate | (g/m² s Pa) | (L/m² s Pa) |
| 1 | EX-1 [GO/s- | 1/100/30 | 3 μm | polypropylene | 6.4 × 10⁻⁵ | |
| | PVA/LiCl] | | | | | |
| 2 | EX-2 [GO/s- | 1/100/30/10 | 3 μm | polypropylene | 7.1 × 10⁻⁵ | |
| | PVA/LiCl/LSU] | | | | | |
| 3 | EX-3 [GO/s- | 1/100/30/0.4 | 3 μm | polypropylene | 10.6 × 10⁻⁵ | |
| | PVA/LiCl/SLS] | | | | | |
| 4 | EX-4 [GO/s- | 1/100/30 | 3 μm | polypropylene | 6 × 10⁻⁵ | |
| | PAA/LiCl] | | | | | |
| 5 | EX-5 [GO/s- | 1/100/30/0.4 | 3 μm | polypropylene | 10.2 × 10⁻⁵ | 5.3 × 10⁻⁷ |
| | PAA/LiCl/SLS] | | | | | |
| 6 | EX-6 [GO/s- | 1/30/70/30/0.4 | 3 μm | polypropylene | 6.0 × 10⁻⁵ | 2.7 × 10⁻⁹ |
| | PVA/PVA/LiCl/SLS] | | | | | |
| 7 | EX-7 [GO/s- | 1/50/50/30/0.4 | 3 μm | polypropylene | 6.4 × 10⁻⁵ | |
| | PVA/PVA/LiCl/SLS] | | | | | |
| 8 | EX-8 [GO/s- | 1/30/70/30/0.4 | 3 μm | polypropylene | 4.4 × 10⁻⁵ | 8.6 × 10⁻⁸ |
| | PAA/PAA/LiCl/SLS] | | | | | |
| 9 | EX-9 GO/s- | 1/100/30 | 3 μm | polypropylene | 5.6 × 10⁻⁵ | 7.2 × 10⁻⁶ |
| | PEEK/LiCl | | | | | |
| 10 | EX-10 GO/s- | 3/100/30/30 | 3 μm | polypropylene | 6.6 × 10⁻⁵ | 7.7 × 10⁻⁷ |
| | PEEK/LSU/LiCl | | | | | |
| 11 | EX-11 [GO/PVA/s- | 1/70/30/2 | 3 μm | polypropylene | 3.2 × 10⁻⁵ | 1 × 10⁻⁹ |
| | PS/SLS] | | | | | |
| 12 | EX-12 [GO/PAA/s- | 1/70/30/30 | 3 μm | polypropylene | 3.5 × 10⁻⁵ | |
| | PS/CaCl₂] | | | | | |

Unless otherwise indicated, all numbers expressing quantities of ingredients, properties such as molecular weight, reaction conditions, and so forth used in the specification and embodiments are to be understood as being modified in all instances by the term “about.” Accordingly, unless indicated to the contrary, the numerical parameters set forth in the specification and attached embodiments are approximations that may vary depending upon the desired properties sought to be obtained. At the very least, and not as an attempt to limit the application of the doctrine of equivalents to the scope of the embodiments, each numerical parameter should at least be construed in light of the number of reported significant digits and by applying ordinary rounding techniques.

The terms “a,” “an,” “the” and similar referents used in the context of describing the examples (especially in the context of the following embodiments) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illuminate the breadth of the present disclosure and does not pose a limitation on the scope of any embodiment. No language in the specification should be construed as indicating any non-embodied element essential to the practice of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the examples of the present disclosure. Of course, variations on these described embodiments will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

1. A membrane for dehydration of a gas, comprising:
a support;
a composite comprising a graphene oxide compound and a sulfonated polymer, wherein the sulfonated polymer comprises sulfonated polyvinyl alcohol, sulfonated polyacrylic acid, sulfonated polyether ether ketone, sulfonated polystyrene, or a combination thereof;
wherein the composite is coated on the support; and
wherein the membrane has high moisture permeability and low gas permeability.

2. The membrane of claim 1, wherein the support is porous.

3. The membrane of claim 1, wherein the support comprises polypropylene, polyethylene terephthalate, polysulfone, polyether sulfone, or a combination thereof.

4. The membrane of claim 1, wherein the weight ratio of the graphene oxide compound to the sulfonated polymer is about 0.001 to about 0.1.

5. The membrane of claim 1, wherein the graphene oxide compound and the sulfonated polymer are cross-linked.

6. The membrane of claim 1, wherein the graphene oxide compound comprises graphene oxide, reduced graphene oxide, functionalized graphene oxide, reduced functionalized graphene oxide, or a combination thereof.

7. The membrane of claim 1, wherein the graphene oxide compound has a platelet size of about 0.05 μm to about 100 μm.

8. The membrane of claim 1, wherein the composite further comprises an alkali metal halide or an alkaline earth metal halide.

9. The membrane of claim 8, wherein the alkali metal halide is lithium chloride and the alkaline earth metal halide is calcium chloride.

10. The membrane of claim 8, wherein the alkali metal halide is lithium chloride and the composite further comprises sodium lignosulfate.

11. The membrane of claim 8, wherein the alkali metal halide is lithium chloride and the composite further comprises sodium lauryl sulfate.

12. The membrane of claim 1, further comprising polyvinyl alcohol.

13. The membrane of claim 1, further comprising polyacrylic acid.

14. The membrane of claim 1, further comprising sodium lauryl sulfate.

15. The membrane of claim 1, wherein the composite is coated on the support as a film having a thickness between about 2 μm to about 400 μm.

16. A method of dehydrating a first gas, comprising applying the membrane of claim 1, to the first gas.

17. The method of claim 16, further comprising applying a water vapor pressure gradient across the membrane to cause water vapor to selectively pass through the membrane, wherein the first gas applies a higher water vapor pressure to a first side of the membrane than a water vapor pressure applied by a second gas to a second side of the membrane, so that water vapor passes through the membrane from the first gas to the second gas.

18. The method of claim 16, wherein the first gas applies a higher total pressure to the first side of the membrane than a total pressure applied by the second gas to the second side of the membrane.

19. The method of claim 16, wherein the first gas is air, oxygen, or nitrogen.

20. The method of claim 16, wherein the membrane has a water vapor permeance of at least 3.2×10⁻⁵ g/m²·s·Pa, and wherein the membrane has a gas permeance of at most 7.2×10⁻⁶ g/m²·s·Pa.

21. (canceled)
